(19) United States
(12) Patent Application Publication
(10) Pub. No.: US 2023/0299589 A1
(43) Pub. Date: Sep. 21, 2023

(54) COORDINATED MANAGEMENT OF AN AGGREGATE TO PROVIDE PRIMARY FREQUENCY CONTROL

(71) Applicant: ELECTRICITE DE FRANCE, Paris (FR)

(72) Inventor: Antoine ROSSE, Paris (FR)

(73) Assignee: ELECTRICITE DE FRANCE, Paris (FR)

(21) Appl. No.: 18/184,156

(22) Filed: Mar. 15, 2023

(30) Foreign Application Priority Data
Mar. 16, 2022 (FR) 2202322

(51) Int. Cl. H02J 3/38; H02J 13/00; G05B 19/042

(52) U.S. Cl. CPC H02J 3/381; G05B 19/042; H02J 13/00002; G05B 2219/2639; H02J 2300/20

(57) ABSTRACT

A method, implemented by a centralized controller, for controlling a virtual power plant connected to the power grid. The virtual power plant includes a battery controlled by a local controller configured to perform primary frequency control of the power grid. The virtual power plant also includes a set of hydroelectric power plants each controlled by a corresponding local controller. The centralized controller provides a power adjustment setpoint to the local controller of the battery so as to compensate for a variation in the total power relative to an overall target power for the set of hydroelectric power plants, and the centralized controller supplies, to at least one local controller of a hydroelectric power plant, at least one power adjustment setpoint, calculated on the basis of a frequency measurement, in accordance with a management strategy for the battery. Figure for abstract: FIG. 4

### FIELD

The present invention relates to the field of hydroelectric power plants, in particular “run-of-river” power plants, and to battery storage systems interfaced by power electronic converters (inverters), connected to a same synchronous power grid.

Aggregations of decentralized sources, also called “virtual power plants” or “VPP”, participate in the primary frequency control of the grid.

The present invention relates more particularly to a method for controlling such a virtual power plant, as well as to a centralized controller implementing such a method and to a computer program intended to be executed by such a centralized controller.

This control method makes it possible to control, in a coordinated manner, a battery and a set of hydroelectric power plants having different dynamic characteristics, in order to provide an aggregated primary frequency control service. This service can in particular be integrated into the “FCR” (“Frequency Containment Reserve”) service, which is the primary frequency control service of the European electricity system.

### BACKGROUND

Today, more and more new technologies, such as battery storage systems, are being installed in power grids in order to provide services such as primary frequency control to the grid. Frequency control has historically been provided by the conventional production means (hydraulic, thermal, nuclear, etc.), and this has a cost for the producer, because in order to ensure the reserve associated with frequency control, the generators must be operated below their rated power.

The use of batteries to provide this frequency control service can make it possible to optimize the conventional production pool. Indeed, if the entire reserve is provided by batteries, this lifts a constraint on conventional generators, which can then be operated at their rated power.

Many frequency control projects using batteries have already been constructed in France and in the rest of the world.

In the literature today, the general technique for managing a single battery participating in primary frequency control (FCR) can be summarized as follows: P_{ref_bat} = P_{FCR}+ P₀.

The term P_{ref_bat} designates the active power setpoint of the battery, the term P_{FCR} designates the power setpoint linked to the frequency control service, and the term P₀ designates the power setpoint linked to charge management for the battery.

The term P_{FCR} is typically calculated by a static law denoted P(f) in the case of a primary frequency reserve released at a frequency difference of 200 MHz. This static law can be described by the equation P(f) = P_{FCR} = - K (f - f₀). The term K is a constant which represents a power-frequency characteristic, the term f designates the frequency of the power grid at a current time, and the term f₀ designates the nominal frequency of the power grid (50 Hz in Europe). The term P_{FCR} is saturated in order to limit the absolute value of the power setpoint linked to the frequency control service, to a threshold denoted RP. FIG. 1 illustrates an example of a static law P(f) in graphical form 1, as a power variation ΔP = P_{FCR} expressed as a function of a frequency variation Δf =f - f₀. In this example, the term P_{FCR} only varies within a limited frequency interval centered on f₀, more precisely within the frequency interval [f₀ -0.2 Hz; f₀ + 0.2 Hz].

When several production means are assembled to provide an aggregated frequency control service, it is possible to carry out decentralized management. In this situation, each production means is provided with its own regulator enabling it to automatically adjust its power as a function of the frequency it measures, according to a static law P(f) such as the one described in the previous paragraph. The power response of the aggregate is then the sum of the power responses of each production means.

With decentralized management, it is also possible to define a different law P(f) for each production means. For example, in an aggregate of two production means, a respective law can be defined for each production means, as illustrated respectively in FIGS. 2 and 3.

FIG. 2 represents a static law P(f) 2 applicable to a given production means, providing:
a linear variation of the term P_{FCR} from RP/2 to -RP/2 when the frequency of the power grid varies from f₀ -0.1 Hz to f₀ + 0.1 Hz,
the term P_{FCR} being saturated at RP/2 or at -RP/2, when the frequency is respectively lower than f₀ - 0.1 Hz or higher than f₀ + 0.1 Hz.

FIG. 3 represents another static law P(f) 3 applicable to another given production means, providing:
a first linear variation of term P_{FCR} from RP/2 to a zero value when the frequency of the power grid varies from f₀ - 0.2 Hz to f₀ - 0.1 Hz, and
a second linear variation of term P_{FCR} from a zero value to -RP/2 when the frequency of the power grid varies from f₀ + 0.1 Hz to f₀ + 0.2 Hz,
the term P_{FCR} also being zero when the frequency of the power grid is between f₀ -0.1 Hz to f₀ + 0.1 Hz,
the term P_{FCR} being saturated at RP/2 or at -RP/2, when the frequency is respectively lower than f₀ - 0.2 Hz or higher than f₀ + 0.2 Hz.

The production means having law P(f) 2 as illustrated by FIG. 2 will be called upon much more than the one having law P(f) 3 as illustrated by FIG. 3, because the latter will only be called upon at frequency deviations greater than 100 mHz. But the sum of the two responses will be equivalent to that of a single production means having control law P(f) 1 as illustrated in FIG. 1. With decentralized management, each production means is autonomous in carrying out its power response to frequency variations.

Another management technique, referred to as “centralized”, consists of using a centralized controller which, based on a frequency measurement f of the grid and a control gain denoted K, calculates an overall reserve setpoint P_{FCR} = - K (f - f₀) and distributes this reserve over all of the production means in the aggregate, for example by subdividing the overall reserve setpoint in proportion to the rated power of each production means, such that the sum of the setpoints is equal to the overall reserve setpoint.

With this centralized management technique, other criteria can be used to dynamically adjust the reserve power provided by each production means. It is therefore possible to have more flexibility in the distribution of the reserve, dynamically, compared to a decentralized management which sets the contributions of each production means via the P(f) laws.

On the other hand, centralized management also implies technical constraints. For it to function, there must be strong communication links between the centralized controller and the production means, so that the power setpoints can be calculated dynamically, i.e. at each change in frequency, the latter varying continuously, and so that these power setpoints are quickly taken into account by the production means to adapt the power of the aggregate according to the frequency variations.

In particular, if the communication delays are too long, it is possible that the response of the aggregate is too slow for the compliance requirements imposed by the Transmission System Operators (TSO).

It is thus apparent that the known management methods for aggregates, both centralized and decentralized, each have their advantages and their limitations.

There is therefore a need for a management method that goes beyond the respective limitations of the centralized and decentralized management methods.

### SUMMARY

This disclosure improves the situation.

A control method is proposed, implemented by a centralized controller, for controlling a virtual power plant connected to the power grid, the virtual power plant comprising at least one battery and a set of hydroelectric power plants, the battery being controlled by a local controller configured to perform primary frequency control of the power grid, each hydroelectric power plant being controlled by a corresponding local controller, the method comprising:
by at least one measurement, obtaining a total power, denoted P_{tot_hydro}, produced by the set of hydroelectric power plants at a given time,
obtaining a measurement of a frequency, denoted f, of the power grid at the given time,
supplying a battery power adjustment setpoint, denoted P_{0_bat}, to the local controller for the battery, calculated on the basis of said total power, said battery power adjustment setpoint being intended to modify the control of the battery by the local controller so as to compensate for a variation in said total power relative to an overall target power for the set of hydroelectric power plants, and
supplying, to at least one local controller of a hydroelectric power plant, at least one power adjustment setpoint for said hydroelectric power plant, denoted P_{flex_i}, calculated on the basis of said frequency measurement, the power adjustment setpoint for said hydroelectric power plant being intended to cause a variation in a power produced by said hydroelectric power plant in accordance with a management strategy for the battery.

The proposed control method makes it possible to offer a primary frequency control service by combining a primary frequency reserve offered by one or more batteries with an additional primary frequency reserve offered by one or more hydroelectric power plants. The sizing of the battery or batteries can thus be optimized.

The use of these combined primary frequency reserves is coordinated and obeys a hybrid management strategy which combines the advantages of the centralized and decentralized management strategies. Local controllers are responsible for managing the production means. They can receive power adjustment setpoints issued by the centralized controller and modify their overall setpoint according to these adjustment setpoints.

Also proposed is a centralized controller configured for controlling a virtual power plant connected to the power grid, the virtual power plant comprising at least one battery and a set of hydroelectric power plants, the battery being controlled by a local controller configured to perform primary frequency control of the power grid, each hydroelectric power plant being controlled by a corresponding local controller, the controlling of the virtual power plant comprising:
by at least one measurement, obtaining a total power, denoted P_{tot_hydro}, produced by the set of hydroelectric power plants at a given time,
obtaining a measurement of a frequency, denoted f, of the power grid at the given time,
supplying a battery power setpoint, denoted P_{0_bat}, to the local controller of the battery, calculated on the basis of said total power, said power setpoint being intended to modify the controlling of the battery by the local controller so as to compensate for a variation in said total power relative to an overall target power for the set of hydroelectric power plants, and
supplying, to at least one local controller of a hydroelectric power plant, at least one power adjustment setpoint, denoted P_{flex_i}, calculated on the basis of said frequency measurement, said power adjustment setpoint being intended to cause a variation in a power produced by said hydroelectric power plant in accordance with a management strategy for the battery.

A computer program is also proposed comprising instructions for implementing the proposed method when this program is executed by a centralized controller.

The proposed method and the proposed centralized controller may optionally comprise certain additional functions as defined below.

Provision may be made to obtain, at the centralized controller, a value for the power-frequency characteristic of the virtual power plant, denoted K, calculated on the basis of an estimate of the amount of available primary frequency reserve of the virtual power plant, i.e. based on an operating point and headroom and footroom power margins of the hydroelectric power plants and the battery. K is a static gain, which does not depend on dynamic variations in power or frequency.

The primary power-frequency characteristic of a declared aggregate in primary frequency regulation represents the amount of power that it can supply to the power grid for a given frequency variation as long as its reserve is not entirely consumed. This power-frequency characteristic is the amount that can be used by the battery’s local controller to determine a setpoint linked to the primary frequency control service of the power grid.

A given power adjustment setpoint, supplied to the local controller of a given hydroelectric power plant, can be calculated by means of a calculation formula selected according to at least one predefined criterion relating to the frequency measurement. Such a predefined criterion may for example be a result of a comparison between, on the one hand, a deviation between the frequency measurement and a nominal frequency value, and on the other hand a predefined threshold.

Thus, for example, the power adjustment setpoint of a hydroelectric power plant can take a non-zero value and be calculated according to a predefined calculation formula when the frequency measurement deviates significantly from the nominal frequency. Otherwise, the power adjustment setpoint may not be calculated and/or may be kept at zero. According to this example, the primary frequency reserve of the hydroelectric power plant is drawn upon only in the event of a frequency deviation to outside a restricted frequency range around the nominal frequency.

Provision may also be made to obtain, at the centralized controller, from the local controller of each hydroelectric power plant, an individualized measurement of the power produced by said hydroelectric power plant at the given time, and to calculate the total power produced by the set of hydroelectric power plants at the given time as being the sum of said individualized measurements of power at the given time.

The centralized controller then acts as a centralized collector of power measurements normally coming from the local controllers of the hydroelectric power plants. Thus, the total power of the virtual power plant can be calculated by the centralized controller, relying solely on the existing equipment at the hydroelectric power plants.

The power adjustment setpoint supplied to the local controller of a hydroelectric power plant can be calculated relative to a base power of said hydroelectric power plant, said base power being calculated on the basis of a criterion that is a function of a history of time-stamped individualized measurements of power produced by said hydroelectric power plant and of a history of power adjustment setpoints previously supplied to the local controller of said hydroelectric power plant.

It is thus possible for example to estimate, for a given hydroelectric power plant and by extrapolation from past power measurements, the share attributable to the consideration of power adjustment setpoints, and to deduce this share from the current power measurements.

Optionally, as each hydroelectric power plant of the virtual power plant has its own primary frequency reserve, the power adjustment setpoint supplied to the local controller of a given hydroelectric power plant can be calculated according to a predefined order of priority for calling upon each of said primary frequency reserves.

Thus, it may be decided to call upon the primary frequency reserves of certain hydroelectric power plants as a priority, and those of other hydroelectric power plants only as a last resort. The order of priority can be set according to any appropriate criterion, in particular relating to the response time of the primary frequency control service and/or to the evolution over time of the availability of the primary frequency reserve at each hydroelectric power plant.

Provision can also be made to obtain, at the centralized controller, a measurement of a state of charge of the battery, and the power setpoint of the battery can further be calculated on the basis of said measurement of the state of charge so as to support maintaining, or returning, the state of charge of the battery to within a predefined range.

The coordinated management of the battery and hydroelectric power plants can thus make it possible to minimize the amplitude of the demands on a battery within a primary frequency control service. More specifically, the cycling window can be reduced by using the primary frequency reserves of hydroelectric power plants. For example, provision may be made to activate lowering the primary frequency reserve of a hydroelectric power plant (i.e. lowering the power emitted by this hydroelectric power plant) to give preference to discharging the battery each time its state of charge approaches a predetermined upper threshold.

### BRIEF DESCRIPTION OF DRAWINGS

Other features, details, and advantages will become apparent upon reading the detailed description below, and upon analyzing the appended drawings, in which:

FIG. 1 illustrates a static law suitable for configuring a power regulator of a production means so as to cause the release of a primary frequency reserve by the production means at a frequency difference of 200 mHz, in one exemplary embodiment.

FIG. 2 and FIG. 3 each illustrate a static law, each suitable for configuring a respective power regulator of a respective production means, so as to jointly cause the release of a primary frequency reserve by these production means at a frequency deviation of 200 mHz, in one exemplary embodiment.

FIG. 4 illustrates an architecture of a virtual power plant management strategy in one exemplary embodiment.

FIG. 5 illustrates, in one exemplary embodiment, an evolution over time:
of a power adjustment setpoint transmitted to a local controller of a hydroelectric power plant,
of a power emitted by said hydroelectric power plant, and
of an estimated base power of said hydroelectric power plant.

FIG. 6 illustrates a static law suitable for defining a power adjustment setpoint which allows configuring a power regulator of a hydroelectric power plant so as to cause the release of a primary frequency reserve by the hydroelectric power plant at a frequency difference of 200 mHz, in one exemplary embodiment.

FIG. 7 illustrates a static law suitable for defining a power adjustment setpoint, or “offset”, applicable to a battery in accordance with a battery charge management strategy, the battery and the hydroelectric power plant being aggregated into a virtual power plant and managed in a coordinated manner to provide a primary frequency control service, in one exemplary embodiment.

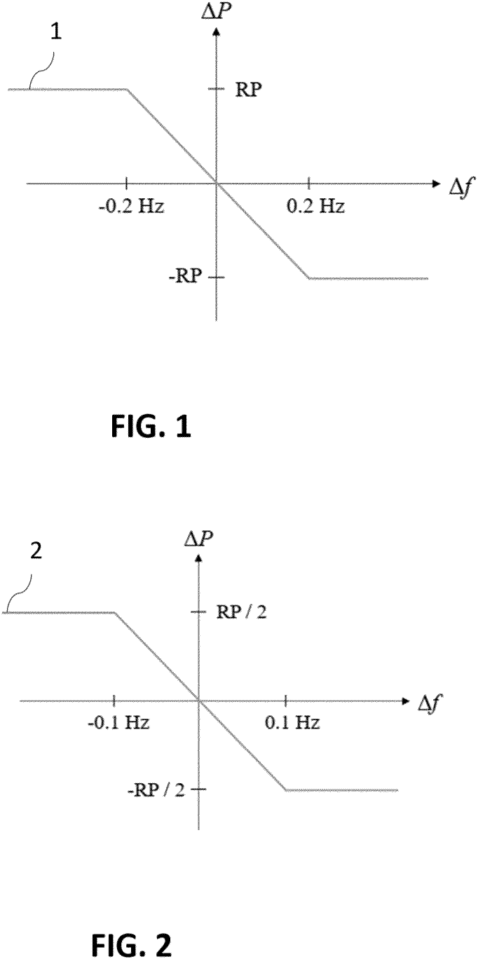

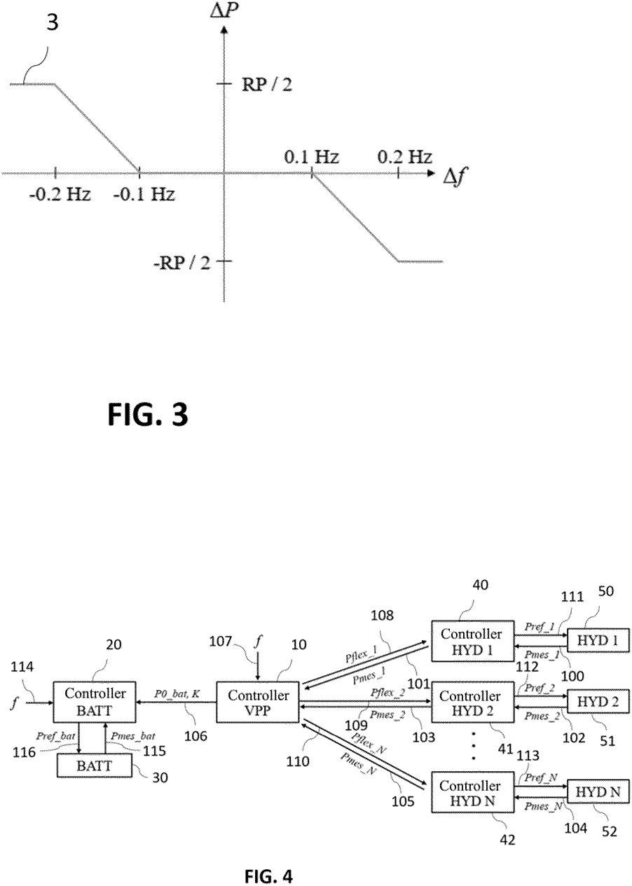

### DETAILED DESCRIPTION

The drawings and the description not only may serve to better understand this disclosure, but where applicable may also contribute to its definition.

The general principle of this disclosure is based on the aggregation of one or more batteries with one or more hydroelectric power plants, for example “run-of-river” power plants. It is proposed to exploit the capacities for flexibility in the active power of this or these hydroelectric power plants in order to supply, as needed, a primary frequency reserve complementary to that of the battery or batteries. This aggregation can allow optimizing both the sizing of the battery(ies) and the use of the hydroelectric power plant(s), from a technical and economic point of view. In hydroelectric power plants, only a simple adaptation of existing controllers is necessary. This adaptation is to enable taking into account an additional setpoint for increasing or decreasing the active power. This setpoint is then added to the one already calculated by the existing equipment regulating the flow and/or level.

The aggregate control process is ingenious in that the set of production means in the aggregate, i.e. the battery(ies) and the hydroelectric power plant(s), are controlled in a coordinated manner to provide a primary frequency control service. An important characteristic of this control method is the hybrid nature of the management of the aggregate’s batteries, which makes it possible to benefit from the advantages of the decentralized and centralized control strategies.

Under normal conditions where the frequency of the synchronous power grid is close to the reference value, i.e. 50 Hz in France, hydroelectric power plants can be placed at their optimum operating point, which depends in particular on the incoming water flow, while one or more batteries provide all of the frequency control by discharging when the frequency is low and recharging when the frequency is high.

In exceptional conditions where the frequency of the synchronous power grid deviates significantly from the reference value, the hydroelectric power plant(s) in the aggregate may occasionally increase or decrease their power in order to provide the additional primary frequency reserve to supplement the power supplied or absorbed by the battery(ies) of the aggregate.

In this manner, the de-optimization of the hydroelectric power plant(s) in the aggregate is limited to these exceptional events, and it is possible to provide the grid with a power reserve greater than the maximum power of the battery(ies) of the aggregate. Thus, the sizing of the battery(ies) can be optimized, which can improve the profitability of a project.

Reference is now made to FIG. 4, which illustrates a general architecture of a control system for an aggregate of production means connected to the power grid, in one exemplary embodiment.

The aggregate is a virtual power plant formed, in this simplified example, of a battery 30 and a plurality of hydroelectric power plants 50, 51, 52.

The battery is managed by a local controller 20 which collects or measures the frequency f of the power grid. Management at the local controller 20 comprises determining an overall power setpoint which incorporates a total or partial contribution to the primary frequency control service. Additional details on battery management are provided further below. In general, the aggregate can obviously comprise a plurality of batteries, each managed either by a dedicated local controller, or by a common controller assuming the same functions as the local controller 20 presented in this example.

The hydroelectric power plants 50, 51, 52 are each controlled by a respective local controller 40, 41, 42 which collects or measures the active power.

The aggregate also has a centralized controller 10 which monitors and manages the entire aggregate by communicating with the various local controllers 20, 40, 41, 42. The centralized controller collects at least the frequency of the power grid at each moment. This or these frequency measurements can be simply obtained via an integrated frequency sensor or transmitted by the local controller 20 of the battery or by any other entity. The centralized controller 10 also collects measurements indicative of the evolution over time of the total power coming from the hydroelectric power plants in the aggregate. These measurements can be for example, for each hydroelectric power plant, a time-stamped reading of the power coming from it. Such readings can be made, for example, by the local controllers 40, 41, 42 of the hydroelectric power plants.

The local controller 20 of the battery controls the battery 30 by issuing an overall setpoint, determined in part on the basis of a partial setpoint transmitted by the centralized controller 10 to the local controller 20 of the battery. Thus, the battery management is called “hybrid”, because the determination of the overall power setpoint involves both the local controller 20 of the battery and the centralized controller 10.

In parallel, the primary frequency control provided by the hydroelectric power plants 50, 51, 52 is centrally controlled. It is the centralized controller 10 which decides at each moment, on the basis of a certain number of criteria, for example on the basis of the difference between the measured frequency of the power grid and the nominal frequency, to activate lowering or raising a primary frequency reserve on one or more hydroelectric power plants. This reserve is said to be complementary in that it can be added to that provided by the battery. This reserve is activated by sending power setpoints to the local controllers 40, 41, 42 of the hydroelectric power plants 50, 51, 52, in order to request them to raise or lower by a certain amount the power of the hydroelectric power plants they control.

One advantage of such an implementation is to allow the aggregation of different types of production means within a virtual power plant, in order to provide a frequency control service:
one or more batteries capable of participating in the frequency control in a decentralized and/or centralized manner with a precise and rapid response, and
hydroelectric power plants not equipped with a speed regulator and which would therefore be unable to participate in frequency regulation in an autonomous or decentralized manner.

Such an aggregation makes it possible to exploit the existing but previously untapped flexibility relating to the power coming from a set of hydroelectric power plants, to participate in stabilization of the grid frequency. The aggregation of hydroelectric power plants with one or more batteries makes it possible to provide a primary frequency control service with a faster and more precise response than is possible with centralized management of a set of hydroelectric power plants not aggregated with a battery.

The strategy combining coordinated control of the battery(ies) and of the hydroelectric power plants makes it possible to optimize the sizing of the battery(ies). Indeed, such a strategy has the advantage of making it possible to relieve the stress on the battery(ies) in order to reduce their cycling, and by extension their aging. Such a strategy has the additional advantage of offering, via the control of hydroelectric power plants, a frequency reserve complementing that of the battery(ies), in particular in the event of significant frequency deviations where the power of the battery(ies) alone would be insufficient.

An example of a management algorithm, suitable for the aggregate shown in FIG. 4, is now detailed.

The primary frequency control performed by the battery 30 is managed by the local controller 20 of the battery, which measures the frequency f of the grid and calculates a power setpoint P_{FCR} intended to ensure this primary frequency control. The power setpoint P_{FCR} can for example follow the conventional law P_{FCR} =- K (f -f₀). Such a law ensures an accurate and fast power response that is proportional to the frequency deviation.

The term K is a constant which represents the power-frequency characteristic of the aggregate. In a known manner, the determination of the constant K results from an estimation or determination of a primary frequency reserve associated with a production means. In such case, it is relevant to estimate or determine the primary frequency reserve of all the combined production means forming the aggregate. The constant K can, for example, be determined by the centralized controller 10, or by any other entity capable of carrying out this determination, then communicated to the local controller 20 of the battery.

The total power setpoint P_{ref_bat} of the battery can be defined, in a simple example, by the law P_{ref_bat} = P_{FCR} + P_{0_bat}, where P_{0_bat} is a power setpoint determined by the centralized controller 10 then communicated to the local controller 20 of the battery.

In addition, the centralized controller at all times monitors the overall power coming from the hydroelectric power plants in the aggregate, i.e. the sum of the powers coming from each of the hydroelectric power plants in the aggregate.

This monitoring offers the centralized controller the possibility of compensating for variations in this overall power in real time, by adjusting the setpoint P_{0_pat} transmitted to the local controller of the battery. This compensation is carried out so that the total power, denoted Pᵥₚₚ, of the production means in the aggregate satisfies the equation Pᵥₚₚ = P_{0_vpp} - K (f-f₀). The term P_{0_vpp} designates the overall target power of the aggregate. This is a predetermined target value for the overall power coming from the set of production means in the aggregate. According to the above equation, Pᵥₚₚ ₌ P_{0_vpp} when the frequency f of the power grid is equal to the nominal frequency f₀.

In other words, setpoint P_{0_bat} is adjusted in real time to compensate for power fluctuations from all of the aggregate’s hydroelectric power plants, denoted P_{tot-hydro}. For example, setpoint P_{0_bat} can be calculated by the equation P_{0_bat} = P_{0_hydro} - P_{tot-hydro}, where the term P_{0_hydro} is a desired overall power setpoint for the set of hydroelectric power plants in the aggregate.

This real-time compensation for variations in power coming from one or more hydroelectric power plants, by one or more batteries, is a closed-loop control over power of hydroelectric origin. This is significant because in general, conventional hydroelectric power plants have a slow and inaccurate power response compared to batteries. This real-time correction by the battery ensures a precise response of the aggregate in relation to the desired overall power setpoint.

The hydroelectric power plants are controlled by a transmission of power adjustment setpoints, denoted P_{flex_i}, from the centralized controller 10 to the local controllers 40, 41, 42 of the hydroelectric power plants in the aggregate. Each setpoint P_{flex_i} is relative. It is added to a setpoint calculated independently by the local controller of each hydroelectric power plant, which in turn is calculated according to the incoming hydraulic flow and/or the level of the reservoir of the power plant, or defined manually by the operator of the power plant or defined by another automated management system.

For each hydroelectric power plant, setpoint P_{flex_i} calculated by the centralized controller 10 is zero, i.e. equal to 0 MW, when no upward or downward activation of the primary frequency reserve specific to each hydroelectric power plant is desired.

The reception of a positive setpoint P_{flex_i} by a local controller of a given hydroelectric power plant leads to an upward activation of the reserve, i.e. a command to increase the active power of the hydroelectric power plant in question.

Conversely, the reception of a negative setpoint P_{flex_i} by a local controller of a given hydroelectric power plant leads to a downward activation of the reserve, i.e. a command to reduce the active power of the hydroelectric power plant in question.

A detailed example of the operation of a control algorithm suitable for managing the aggregate is now described in connection with FIG. 4.

In each time increment, the following actions are executed by the centralized controller 10. The centralized controller 10 obtains 101, 103, 105 a power measurement P_{mes_i} from each hydroelectric power plant. These power measurements P_{mes_i} are respectively made 100, 102, 104 by sensors, then transmitted by the sensors to the local controllers 40, 41, 42 of the hydroelectric power plants, and then transmitted by the local controllers 40, 41, 42 to the centralized controller 10. The centralized controller 10 calculates the sum of these power measurements in order to obtain the total power P_{tot-hydro} produced by the hydroelectric power plants 50, 51, 52 in the aggregate. The algorithm embedded in the centralized controller 10 compares value P_{tot_hydro} with an overall target power P_{0_hydro} of the hydroelectric power plants in the aggregate and calculates its contribution P_{0_bat} to the overall power setpoint of the battery on the basis of this comparison, for example by the equation P_{0_bat} = P_{0_hydro} - P_{tot_hydro}. The algorithm embedded in the centralized controller 10 also obtains 107 a measurement of the grid frequency, and calculates, for each hydroelectric power plant in the aggregate, as a function of this frequency measurement and of a set of predefined criteria, a respective power setpoint P_{flex_i}. The centralized controller 10 can then transmit 106, via a first communication link, the setpoint P_{0_bat} and the control gain K to the local controller 20 of the battery 30. The centralized controller 10 can also transmit 108, 109, 110, via other communication links, setpoints P_{flex_i} to the local controllers 40, 41, 42 of the corresponding hydroelectric power plants.

In parallel with the actions of the centralized controller 10, the following actions are executed in each time increment by the local controller 20 of the battery 30. The local controller 20 is capable of obtaining setpoint P_{0_bat} and the control gain K via the communication link with the centralized controller 10. The local controller 20 then calculates, from a received measurement 114 of the grid frequency and from the gain K transmitted by the centralized controller 10, the overall setpoint of the battery as being P_{ref_bat} = -K (f - f₀) + P_{0_bat}. The local controller 20 transmits 116 the overall setpoint P_{ref_bat} to the battery 30, which then produces a power equal to this setpoint if its limitations in power and state of charge so allow. Optionally, the local controller 20 can measure 115 the power actually produced by the battery and/or its state of charge, for control purposes.

In parallel with the actions of the centralized controller 10 and the local controller 20 of the battery 30, the following actions are executed at each time increment by the local controllers 40, 41, 42 of each hydroelectric power plant 50, 51, 52. Each local controller 40, 41, 42 obtains 100, 102, 104 a power measurement from the hydroelectric power plant that it controls and transmits this to the centralized controller 10 via the communication link with said controller. Each local controller 40, 41, 42 is capable of obtaining a setpoint P_{flex_i} in return, via the communication link with the centralized controller 10. Each local controller 40, 41, 42 having received such a setpoint P_{flex_i} adds 111, 112, 113 this to its internal power setpoint. Thus, the power of the hydroelectric power plant concerned 50, 51, 52 increases or decreases according to the setpoint P_{flex_i} applied.

An example of a method for calculating the overall setpoint P_{0_hydro} for the set of hydroelectric power plants in the aggregate excluding the contribution to the primary frequency control is now described with reference to an example scenario illustrated in FIG. 5. The overall setpoint P_{0_hydro} represents the overall power coming from the hydroelectric power plants in the aggregate in stabilized mode when all setpoints P_{flex_i} are equal to 0 MW. One method of calculating this amount P_{0_hydro} consists of respectively estimating a base power P_{0_hydro} (i) for each hydroelectric power plant in the aggregate, then calculating the sum of these base powers.

FIG. 5 shows three curves, each representing the value of an amount as a function of time.

More specifically, a first curve 4 shows the evolution over time of the values of setpoint P_{flex_i} successively transmitted, at each time increment, by the centralized controller 10 to a local controller 40 of one of the hydroelectric power plants in the aggregate. In this example, the transmitted values of setpoint P_{flex_i} are zero between times T0 and T1, then non-zero, and more specifically positive between times T1 and T2, and finally zero again starting at time T2.

A second curve 5 shows the evolution over time of the power P_{mes_i}, measured at each time increment, actually produced by this hydroelectric power plant. A power plateau P_{mes_i} is observed, with an offset corresponding to the response time of the hydroelectric power plant, after the transmission of positive setpoints P_{flex_i}, between times T1 and T2.

A third curve 6 shows the evolution over time of the base power P_{0_hydro} (i) of this hydroelectric power plant, determined according to the proposed exemplary calculation method. The base power P_{0_hydro} (i) of each hydroelectric power plant in the aggregate can be calculated on the basis of a predetermined condition, or rule.

By way of example, the following condition is defined: if and only if setpoint P_{flex_i} received by the local controller of a given hydroelectric power plant is and remains zero (P_{flex_i} = 0 MW) continuously for a predetermined period of time (for example one minute), then the base power P_{0_hydro} (i) retained for this hydroelectric power plant is considered to be equal to the last recorded power measurement from this hydroelectric power plant. In FIG. 5, this condition is considered satisfied in a first time interval ending at time T1 and in a second time interval starting at time T3. In these two intervals, P_{0_hydro} (i) is equal to P_{mes_i}.

Otherwise, the base power P_{0_hydro} (i) is frozen, kept constant and equal to the last previously retained value of P_{0_hydro} (i). In FIG. 5, this case is encountered in the time interval starting at time T1 and ending at time T3. Indeed, starting at time T1, the aforementioned condition is no longer satisfied because the value of P_{flex_i} becomes non-zero, and remains so until time T2. It is only starting at time T3, corresponding to the ending of a predetermined period of time beginning at time T2, that the aforementioned condition is again satisfied.

The predetermined rule thus described ignores any evolution over time in the incoming hydraulic flow or in the level of the reservoir of the power plant, as long as the aforementioned condition is not satisfied. Such evolutions over time can be modeled to refine the determination, at each time increment, of the base power P_{0_hydro}.

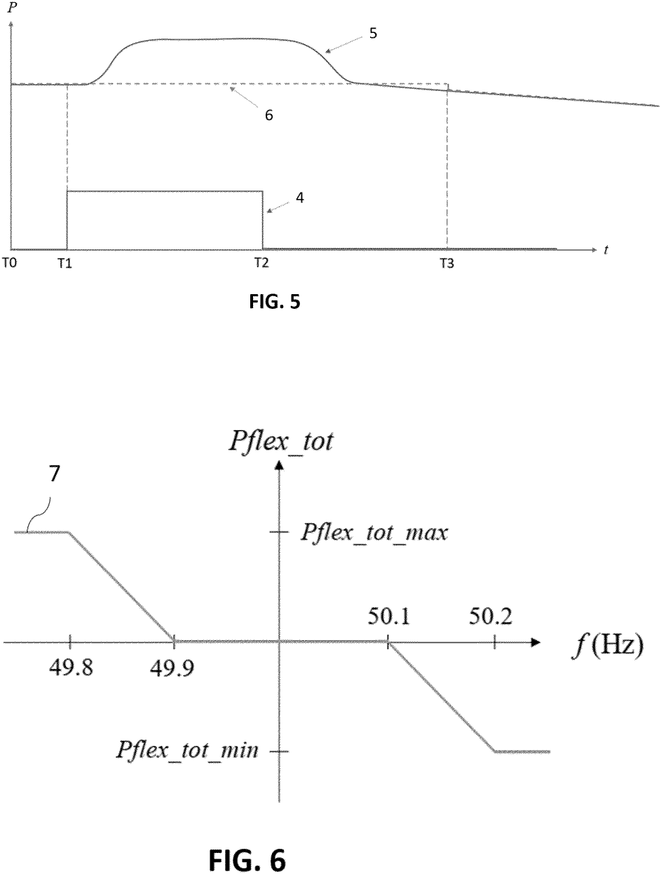

An example of a criterion for activating the reserve of hydroelectric power plants is now described by considering a nominal frequency of 50 Hz. In this example, a static law 7 expressing an overall setpoint P_{flex_tot} as a function of the frequency can thus be defined, as illustrated in FIG. 6.

The setpoints P_{flex_i} of hydroelectric power plants are all fixed at a zero value when the measured grid frequency is stable and close to 50 Hz, because in this situation, the battery alone can provide all of the frequency control. If the grid’s measured frequency falls below a lower threshold, for example 49.9 Hz, the upward activation of the primary frequency reserve of hydroelectric origin is requested by a positive overall setpoint P_{flex_tot} that is proportional to the frequency deviation below 49.9 Hz. If the grid frequency passes above an upper threshold, for example 50.1 Hz, the downward activation of the primary frequency reserve of hydroelectric origin is requested by a negative overall setpoint P_{flex_tot} that is proportional to the frequency difference beyond 50.1 Hz. Moreover, the absolute value of the overall setpoint P_{flex_tot} is saturated, given the necessarily finite amplitude of the primary frequency reserve of hydroelectric origin. Next, setpoint P_{flex_tot} is broken down into setpoints P_{flex_i} which are each transmitted to a respective local controller of a respective hydroelectric power plant. This breakdown can be carried out in several ways, for example in proportion to the power of each hydroelectric power plant, or by following a predefined order of priority. An example of an order of priority could be to first place the maximum possible reserve on the hydroelectric power plant that has the highest rank in the order of priority. Then, if the placed reserve is less than the overall setpoint P_{flex_tot}, the maximum possible reserve is also placed on the hydroelectric power plant having the second rank in the order of priority, and so on, until it is ensured that the sum of the setpoints P_{flex_i} corresponding to the placed reserves is greater than or equal to the overall demand P_{flex_tot}.

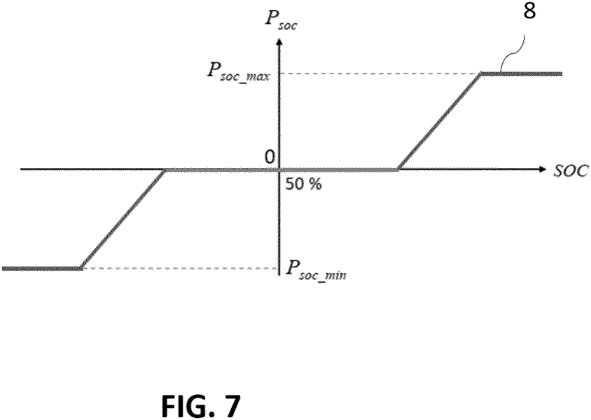

A variant of the control method described above is now proposed. In this variant, the setpoint P_{0_bat} sent by the centralized controller 10 to the local controller 20 of the battery is not simply the result of the equation P_{0_bat} = P_{0_hydro} - P_{tot_hydro}. On the contrary, in this variant the setpoint P_{0_bat} contains a power component P_{soc} which makes it possible to manage the state of charge of the battery and thus prevent it from charging or discharging beyond certain thresholds. Several battery state-of-charge management strategies are well known today in the literature. An example of a classic strategy is the use of a static charge management law P_{soc} = f(SOC), where SOC designates the current state of charge of the battery, measurable at the local controller 20 of the battery and able to be transmitted to the centralized controller 10. An example of such a static law 8 is shown in FIG. 7.

The objective of the charge management law is to increase the battery power when the state of charge is high to support discharging, and to decrease the battery power when the state of charge is low to support charging.

Thus, in the proposed variant, the term P_{soc} can be calculated by the centralized controller 10 and integrated into the setpoint P_{0_bat} sent to the local controller 20 of the battery. In this case, the measurement of the battery’s state of charge must be transmitted by the battery’s local controller 20 to the centralized controller 10 via the communication link between the two. Calculation of the term P_{0_bat} then becomes P_{0_bat} = P_{0_hydro} - P_{tot_hydro} + Psoc.

Alternatively, the term P_{soc} can be calculated by the local controller 20 of the battery, and in this case the term P_{soc} does not change in comparison to the basic operation, but the calculation of the final setpoint of the battery performed by the battery’s local controller 20 is changed in order to calculate and integrate the component P_{soc}. The calculation performed by the local battery controller then becomes P_{ref_bat} = - K (f - f₀) + P_{0_bat} + P_{soc}.

1. A method, implemented by a centralized controller, for controlling a virtual electric power plant connected to the power grid, the virtual power plant comprising at least one battery and a set of hydroelectric power plants, the battery being controlled by a local controller configured to perform primary frequency control of the power grid, each hydroelectric power plant being controlled by a corresponding local controller,
the method comprising:
by at least one measurement, obtaining a total power produced by the set of hydroelectric power plants at a given time,
obtaining a measurement of a frequency of the power grid at the given time,
supplying a battery power adjustment setpoint to the local controller for the battery, calculated on the basis of said total power, said battery power adjustment setpoint being intended to modify the control of the battery by the local controller so as to compensate for a variation in said total power relative to an overall target power for the set of hydroelectric power plants, and
supplying, to at least one local controller of a hydroelectric power plant, at least one power adjustment setpoint for said hydroelectric power plant calculated on the basis of said frequency measurement, the power adjustment setpoint for said hydroelectric power plant being intended to cause a variation in a power produced by said hydroelectric power plant in accordance with a management strategy for the battery.

2. The method according to claim 1, further comprising:
obtaining a value for the power-frequency characteristic of the virtual power plant calculated on the basis of an estimate of an amount of available primary frequency reserve of the virtual power plant.

3. The method according to claim 1, wherein the power adjustment setpoint supplied to the local controller of a hydroelectric power plant is calculated by means of a calculation formula selected according to at least one predefined criterion relating to the frequency measurement.

4. The method according to claim 3, wherein at least one predefined criterion is a result of a comparison between, on the one hand, a deviation between the frequency measurement and a nominal frequency value, and on the other hand a predefined threshold.

5. The method according to claim 1, further comprising:
obtaining, from the local controller of each hydroelectric power plant, an individualized measurement of the power produced by said hydroelectric power plant at the given time, and
calculating the total power produced by the set of hydroelectric power plants at the given time as being the sum of said individualized measurements of power at the given time.

6. The method according to claim 1, wherein:
the power adjustment setpoint supplied to the local controller of a hydroelectric power plant is calculated relative to a base power of said hydroelectric power plant,
said base power being calculated on the basis of a criterion that is a function of a history of time-stamped individualized measurements of power produced by said hydroelectric power plant and of a history of power adjustment setpoints previously supplied to the local controller of said hydroelectric power plant.

7. The method according claim 1, wherein, each hydroelectric power plant of the virtual power plant having its own primary frequency reserve:
the power adjustment setpoint supplied to the local controller of a given hydroelectric power plant is calculated according to a predefined order of priority for calling upon each of said primary frequency reserves.

8. The method according to claim 1, further comprising:
obtaining a measurement of a state of charge of the battery, and
wherein the power setpoint of the battery is further calculated on the basis of said measurement of the state of charge so as to support maintaining, or returning, the state of charge of the battery to within a predefined range.

9. A centralized controller configured for controlling a virtual power plant connected to the power grid, the virtual power plant comprising at least one battery and a set of hydroelectric power plants, the battery being controlled by a local controller configured to perform primary frequency control of the power grid, each hydroelectric power plant being controlled by a corresponding local controller,
the controlling of the virtual power plant comprising:
by at least one measurement, obtaining a total power produced by the set of hydroelectric power plants at a given time,
obtaining a measurement of a frequency of the power grid at the given time,
supplying a battery power setpoint to the local controller of the battery, calculated on the basis of said total power, said power setpoint being intended to modify the controlling of the battery by the local controller so as to compensate for a variation in said total power relative to an overall target power for the set of hydroelectric power plants, and
supplying, to at least one local controller of a hydroelectric power plant, at least one power adjustment setpoint calculated on the basis of said frequency measurement, said power adjustment setpoint being intended to cause a variation in a power produced by said hydroelectric power plant in accordance with a management strategy for the battery.

10. A non-transitory computer-readable medium storing a computer program including instructions that, when executed by a processor, causes a centralized controller to control a virtual power plant connected to the power grid, the virtual power plant comprising at least one battery and a set of hydroelectric power plants, the battery being controlled by a local controller configured to perform primary frequency control of the power grid, each hydroelectric power plant being controlled by a corresponding local controller, the controlling of the virtual power plant comprising:
by at least one measurement, obtaining a total power produced by the set of hydroelectric power plants at a given time,
obtaining a measurement of a frequency of the power grid at the given time,
supplying a battery power setpoint to the local controller of the battery, calculated on the basis of said total power, said power setpoint being intended to modify the controlling of the battery by the local controller so as to compensate for a variation in said total power relative to an overall target power for the set of hydroelectric power plants, and
supplying, to at least one local controller of a hydroelectric power plant, at least one power adjustment setpoint calculated on the basis of said frequency measurement, said power adjustment setpoint being intended to cause a variation in a power produced by said hydroelectric power plant in accordance with a management strategy for the battery.
